(19) United States
(12) Patent Application Publication
(10) Pub. No.: US 2014/0052902 A1
(43) Pub. Date: Feb. 20, 2014

(54) ELECTRONIC DEVICE AND METHOD OF GENERATING VIRTUAL UNIVERSAL SERIAL BUS FLASH DEVICE

(71) Applicants: Hon Hai Precision Industry Co., Ltd., New Taipei (TW); Hong Fu Jin Precision Industry (ShenZhen) Co., Ltd., Shenzhen (CN)

(72) Inventor: SAN-YI SHU, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 13/957,562

(22) Filed: Aug. 2, 2013

(30) Foreign Application Priority Data
Aug. 16, 2012 (CN) 2012102921882

(51) Int. Cl. G06F 12/02

(52) U.S. Cl. CPC G06F 12/0246
USPC 711/103

(57) ABSTRACT

An electronic device connected to several USB devices. The electronic device divides a memory of each USB device to a plurality of memory blocks. Corresponding memory blocks of each USB device are combined to sectors. All the sectors form a virtual USB flash device. When data need to be written to the USB flash drive, the data is divided to data blocks according to a size of each memory block. The data blocks of the data are stored into the memory blocks of each sector. When the data need to be read from the virtual USB flash device, the data blocks of the data are read from the memory blocks of corresponding sectors. The electronic device combines the data blocks to integrated data.

### BACKGROUND

1. Technical Field

Embodiments of the present disclosure relate to universal serial bus (USB) flash drive management technology, and more particularly to an electronic device and a method of generating a virtual USB flash device.

2. Description of related art

Each USB device accords with a standard, such as a standard 2.0. A USB device with the standard 2.0 reads data up to a speed of 10-15 MB person second, and writes data up to a speed of 5-10 MB person second. The speed of reading and writing data by the USB device is very slow, so that when a large amount of data needs be transferred from/to a USB 2.0 device, a lot of time may be wasted.

### BRIEF DESCRIPTION OF THE DRAWINGS

FIG. 1 is a block diagram of one embodiment of an electronic device including a generation system.

FIG. 2 is a block diagram of one embodiment of function modules of the generation system in FIG. 1.

FIG. 3 is a flowchart of one embodiment of a method of generating a virtual USB flash device.

FIG. 4 is a schematic diagram illustrating one embodiment of the virtual USB flash device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

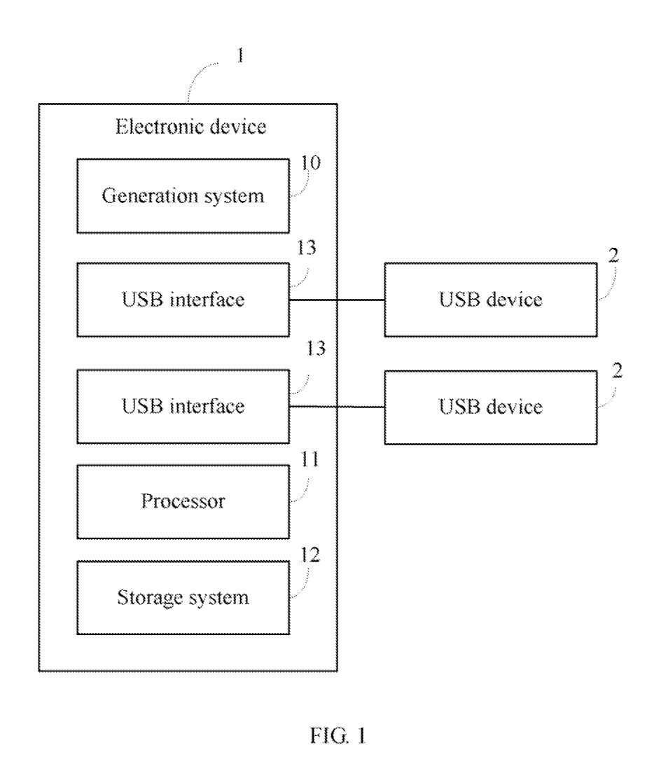

FIG. 1 is a block diagram of one embodiment of an electronic device 1 including a generation system 10, a processor 11 and a storage system 12. The electronic device 1 may be a computer, or a server, for example. The electronic device 1 includes more than one USB interface 13. In one embodiment, a number of the USB interface 13 is not less than two. Each USB interface 13 is connected to a USB device 2. The USB device 2 may be a USB drive, or a portable hard disk, for example. The storage system 12 stores a device driver application for each USB device 2 and a virtual driver.

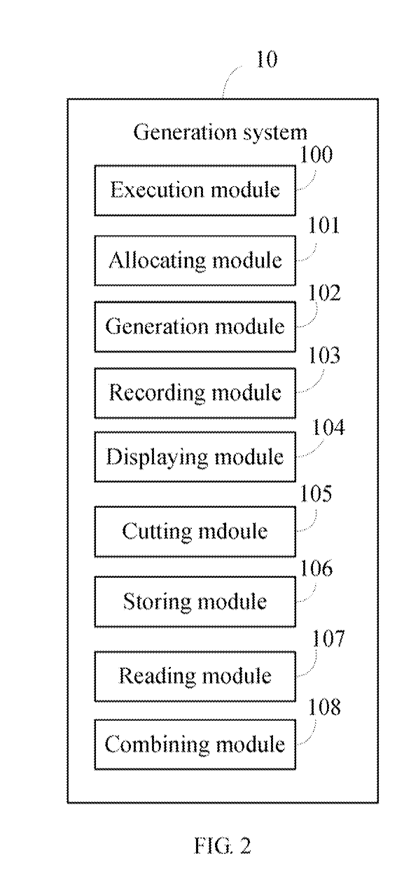

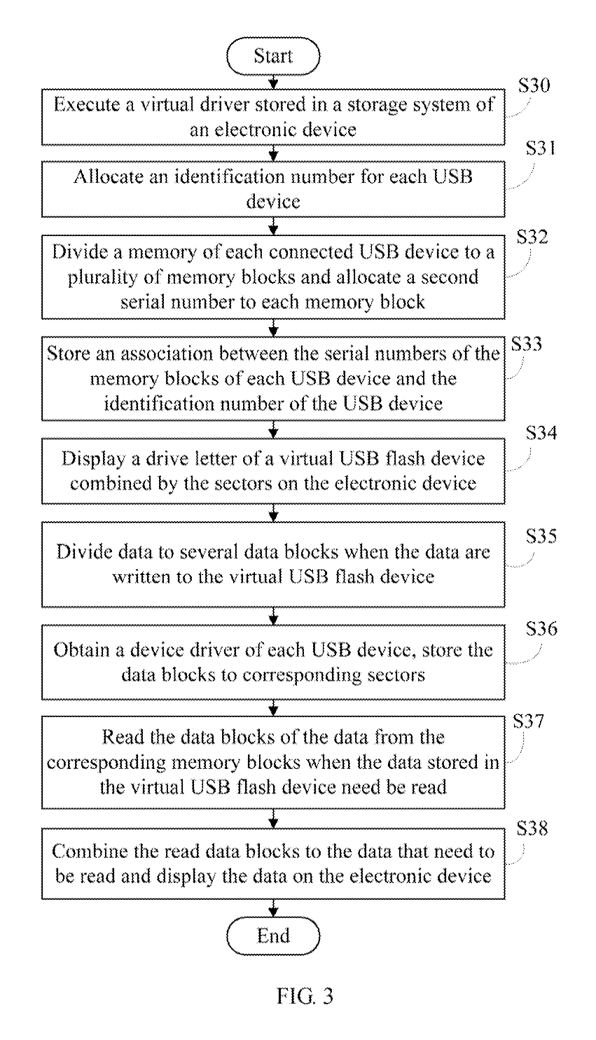

As shown in FIG. 2, the generation system 10 includes a plurality of function modules, such as an execution module 100, an allocating module 101, a generation module 102, a recording module 103, a displaying module 104, a cutting module 105, a storing module 106, a reading module 107, and a combining module 108. The modules 100-108 include computerized code in the form of one or more programs that are stored in the storage system 12. The computerized code includes instructions that are executed by the processor 11, to provide aforementioned functions of the generation system 10. Detailed functions of the modules 100-108 are given in reference to FIG. 3.

FIG. 3 is a flowchart of one embodiment of method of generating a virtual USB flash device. Depending on the embodiment, additional steps may be added, others removed, and the ordering of the steps may be changed.

In step S30, when the USB devices 2 are connected to the electronic device 1 via the USB interface 13, the execution module 100 executes the virtual driver stored in the storage system 12. In one embodiment, two USB devices 2 are connected to the electronic device 1. The electronic device 1 may provide an interface for a user to select the connected USB devices 2. Memory blocks of the selected USB devices 2 are used to constitute a virtual USB flash device.

In step S31, the allocating module 101 allocates an identification number to each connected USB device 2. For example, an identification number of a first USB device 2 may be “1” and an identification number of a second USB device 2 may be “2.”

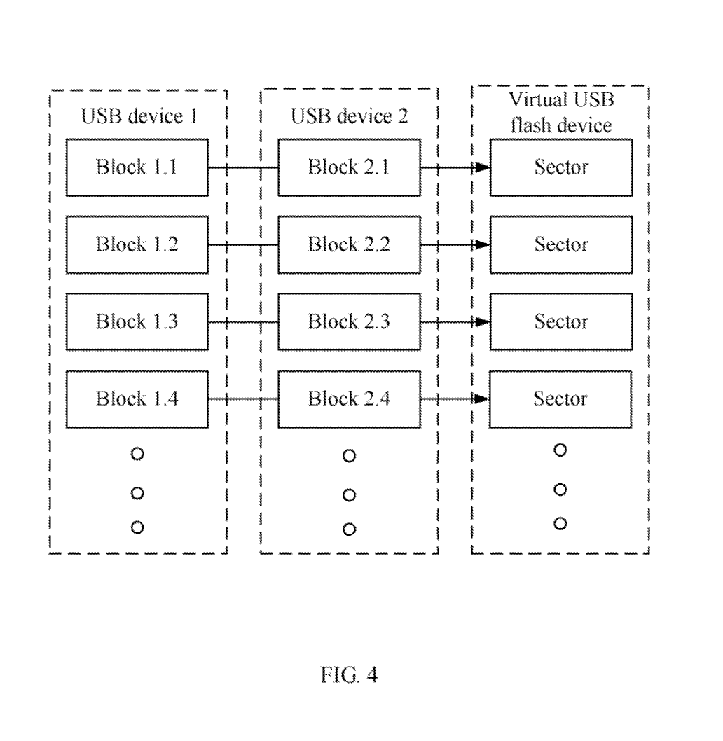

In step S32, the generation module 102 divides a memory of each connected USB device 2 to a plurality of memory blocks according to an operating system of each connected USB device 2. A quantity of the memory blocks of each connected USB device 2 is the same as each other. The generation module 102 allocates a serial number to each memory block and uses the memory blocks to form sectors of the virtual USB flash device. In one embodiment, a size of a memory block should be a multiple of 512 bytes. The size of a memory block is allowed by the operating system of the connected USB device 2. For example, if sizes of the memory of the first USB device 2 and the memory of the second USB device 2 are 16M, the generation module 102 respectively divides the memory of the first USB device 2 and the memory of the second USB device 2 into 16*1024*1024/512=32768 memory blocks. As shown in FIG. 4, the identification numbers of the memory blocks of the first USB device 2 include 1.1, 1.2, 1.3, 1.4, and the serial numbers of the memory blocks of the second USB device 2 include 2.1, 2.2, 2.3, 2.4, then the generation module 102 combines the block 1.1 and the block 2.1 to form a first sector of the virtual USB flash device, combines the block 1.2 and the block 2.2 to form a second sector of the virtual USB flash device, and combines the block 1.3 and the block 2.3 to form a third sector of the virtual USB flash device. Therefore, storage space of each sector of the virtual USB flash device is 512*2=1024 bytes.

In step S33, the recoding module 103 stores an association between the serial numbers of the memory blocks of each USB device 2 and the identification number of the USB device 2. For example, the identification number of the first USB device 2 is “1.” The serial number of the memory blocks of the first USB device include “1.1, 1.2, 1.3, 1.4.” The serial numbers “1.1, 1.2, 1.3, 1.4” of the memory blocks of the first USB device are associated with the identification number “1” of the first USB device 2. Therefore, when next time the USB device 2 is connected to the electronic device 1, there is no need to divide the memory of the USB device 2 again. The virtual USB flash device can be operated directly by recognizing the association between the serial numbers and the identification number of the USB device 2.

In step S34, the displaying module 104 displays a drive letter of the virtual USB flash device on the electronic device 1.

In step S35, when data are written to the virtual USB flash device, the cutting module 105 divides the data to several data blocks according to a size of the data and the size of each memory block of each USB device 2. The cutting module 105 further allocates an identifier to each data block. If the size of the memory of each USB device 2 is the same, the cutting module 105 averagely divides the data to obtain the data blocks. A size of each data block equals the size of each block of the USB device 2. For example, if a size of a memory of the virtual USB flash device is 4096 bytes and the virtual USB flash device includes four sectors, then a size of each sector is 1024 bytes. When 1600 bytes data needs be written to the virtual USB flash device, the cutting module 105 divides the data to four data blocks. The size of the four data blocks are 512 bytes, 512 bytes, 512 bytes and 64 bytes, then the four data blocks are separately stored into the block 1.1, block 1.2, block 2.1, and block 2.2.

In step S36, the storing module 106 obtains the device driver of each USB device 2 from the storage system 12, stores the data blocks to corresponding sectors, and records the identifier of each data block and the serial number of each memory block. Because that a sector includes more than one memory block, the storing module 106 may store the data blocks into the memory blocks of the sectors synchronously. The synchronous storing can save a lot of time.

In step S37, when data stored in the virtual USB flash device need to be read, the reading module 107 reads data blocks of the data from the corresponding memory blocks according to the identifier of each data block and the serial number of the memory block in which the data block are stored.

In step S39, the combining module 108 combines the read data blocks to form the data that need to be read according to the identifier of the read data blocks, and displays the data on the display device of the electronic device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device being connected with one or more USB device, the electronic device comprising:
a processor; and
a non-transitory computer-readable medium that stores one or more programs, which comprise instructions which when executed by the processor of the electronic device, performs operations of:
(a) dividing a memory of each USB device to a plurality of memory blocks, allocating a serial number to each memory block, and combining the memory blocks to form sectors of a virtual USB flash device according to the serial numbers; and
(b) displaying a drive letter of the virtual USB flash device on a display device of the electronic device.

2. The electronic device as claimed in claim 1, wherein before operation (a) further comprises:
executing a virtual driver stored in the electronic device.

3. The electronic device as claimed in claim 1, wherein after operation (b) further comprises:
dividing data into several data blocks according to a size of the data and a size of each memory block of each USB device, and allocating an identifier to each data block; and
storing the data blocks to corresponding sectors and recording the identifier of each data block and the serial number of each memory block.

4. The electronic device as claimed in claim 3, wherein the operations further comprises:
reading data blocks of the data according to the identifier of each data block and the serial number of the memory block in which the data block are stored when the data need to be read from the virtual USB flash device; and
combining the read data blocks to form the data that needs to be read according to the identifiers of the read data blocks, and displaying the data on the electronic device.

5. A method being executed by a processor of an electronic device, comprising steps:
(a) dividing a memory of each USB device to a plurality of memory blocks, allocating a serial number to each memory block, and combining the memory blocks to form sectors of a virtual USB flash device according to the serial numbers; and
(b) displaying a drive letter of the virtual USB flash device on a display device of the electronic device.

6. The method as claimed in claim 5, wherein before operation (a) the method further comprises:
executing a virtual driver stored in the electronic device.

7. The method as claimed in claim 5, wherein the method further comprising:
dividing data to several data blocks according to a size of the data and a size of each memory block of each USB device, and allocating an identifier to each data block; and
storing the data blocks into corresponding sectors and recording the identifier of each data block and the serial number of each memory block.

8. The method as claimed in claim 7, wherein the method further comprising:
reading data blocks of the data according to the identifier of each data block and the serial number of the memory block in which the data block are stored when the data need to be read from the virtual USB flash device; and
combining the read data blocks to form the data that needs to be read according to the identifiers of the read data blocks, and displaying the data on the electronic device.

9. A non-transitory computer-readable medium having stored thereon instructions that, when executed by a processor of an electronic device, cause the processor to perform operations of:
(a) dividing a memory of each USB device to a plurality of memory blocks, allocating a serial number to each memory block, and combining the memory blocks to form sectors of a virtual USB flash device according to the serial numbers; and
(b) displaying a drive letter of the virtual USB flash device on a display device of the electronic device.

10. The non-transitory computer-readable medium as claimed in claim 9, wherein before operation (a) the method further comprises:
executing a virtual driver stored in the electronic device.

11. The non-transitory computer-readable medium as claimed in claim 9, wherein the method further comprising:
dividing data into several data blocks according to a size of the data and a size of each memory block of each USB device, and allocating an identifier to each data block; and
storing the data blocks to corresponding sectors and recording the identifier of each data block and the serial number of each memory block.

12. The non-transitory computer-readable medium as claimed in claim 11, wherein the method further comprising:
reading data blocks of the data according to the identifier of each data block and the serial number of the memory block in which the data block are stored when the data need to be read from the virtual USB flash device; and
combining the read data blocks to form the data that needs to be read according to the identifiers of the read data blocks, and displaying the data on the electronic device.
